(19) United States
(12) Patent Application Publication
(10) Pub. No.: US 2026/0108980 A1
(43) Pub. Date: Apr. 23, 2026

(54) LASER DIRECTION GUIDING ASSEMBLY AND LASER PROCESSING DEVICE HAVING THE SAME

(71) Applicant: E&R ENGINEERING CORPORATION, Kaohsiung City (TW)

(72) Inventor: Schang-Jing HON, Kaohsiung City (TW)

(21) Appl. No.: 19/019,693

(22) Filed: Jan. 14, 2025

(30) Foreign Application Priority Data
Oct. 21, 2024 (TW) 113139985

(51) Int. Cl. B23K 26/06

(52) U.S. Cl. CPC B23K 26/0643; B23K 26/0648

(57) ABSTRACT

A laser direction guiding assembly used in a laser processing device comprises an offsetting mirror set, a first-axis mirror set, and a second-axis mirror set. A laser beam is emitted to the laser direction guiding assembly, firstly is deflected by an offsetting reflection mirror of the offsetting mirror set and reflected to a first-axis reflection mirror of the first-axis mirror set, then is deflected to a second-axis reflection mirror of the second-axis mirror set. By the offsetting mirror set reducing an angular difference between two routes at two opposite sides of the laser beam, when the laser beam is emitted out from the second-axis reflection mirror, the angular difference between the two routes of the laser beam is also reduced. Therefore, the laser beam is emitted to a to-be-processed object with a smaller inclined angle, hence improving processing quality and accuracy of the laser processing device.

### BACKGROUND OF THE INVENTION

### 1. Field of the Invention

The present invention relates to a laser direction guiding assembly, especially to a guiding mirror assembly configured to apply in a laser processing device to adjust a laser beam's direction.

### 2. Description of Related Art

In semiconductor processing, a via-forming process uses a laser processing device emitting a Bessel laser beam to a preset position of a substrate for modification. Then, etching is processed at the position to form a via on the substrate.

The laser processing device comprises a moving platform, a laser emitter, a mirror assembly, and a concentrating lens set. The substrate is placed on the moving platform. The laser emitter emits a Bessel laser beam to the mirror assembly, which adjusts directions of the laser beam and reflects the laser beam to the concentrating lens set. The concentrating lens set then makes the beam focus on a certain height. An area on which the beam focuses is on the substrate, which is placed on the moving platform, so the preset position of the substrate is in the focusing area and thus is modified.

A conventional mirror assembly comprises a first-axis mirror set and a second-axis mirror set. The laser emitter emits a laser beam to a reflecting mirror of the first-axis mirror set, making the beam deflect along a first angle to control a first-axis coordinate location of the laser beam when it is on the substrate. After deflected by the first-axis mirror set, the laser beam then is emitted to a reflecting mirror of the second-axis mirror set, so the laser beam is deflected along a second angle and the first angle to control a second-axis coordinate location of the laser beam when it is emitted to the substrate. After deflected by the second-axis mirror set, the laser beam is emitted to the concentrating lens set.

Only the incident beam that is within a smaller incident angle range can be emitted out vertically from the concentrating lens set. However, the Bessel laser beam is doughnut-shaped, so the outer diameter of the laser beam has a certain degree of width. While directions of the laser beam are adjusted through the mirror assembly, after the Bessel beam is deflected by the first-axis mirror set, not only the direction of the beam is deflected along the first angle, but an angular difference occurs between two light routes at two opposite sides of the doughnut-shaped beam. Then, after the Bessel beam is deflected by the second-axis mirror set, not only the direction of the beam is deflected along the first angle and the second angle, but the deflection of the Bessel beam along the first angle is enlarged. So, the angular difference between the two light routes at the two opposite sides of the doughnut-shaped beam is enlarged as well. Hence, the two light routes at the two opposite sides of the doughnut-shaped beam enter the concentrating lens set with a larger angular difference, so the beam emitted out of the concentrating lens set is inclined.

The beam emitted out of the concentrating lens set being inclined means the beam focuses poorly, thus causing the following drawbacks. First, a poorly focusing beam lacks energy concentration, which leads to poor processing quality. Second, the inclined beam forms inclined vias on the substrate, thus lacking processing accuracy. Furthermore, the directions of the beam are adjusted by the mirror assembly, and then the beam passes through the concentrating lens set to be emitted to different positions, which have different first axial coordinate locations and different second axial coordinate locations, on the substrate. That is been said, when the laser beam is emitted at different positions, the laser beam has different inclined angles, so vias formed on the substrate also have different inclined angles. For example, as shown in FIG. 5, two vias 61 on the substrate 6 respectively have two openings 611 on a top side of the substrate 6 and respectively have two openings 612 on a bottom side of the substrate 6. Because a distance between the two openings 611 and a distance between the two openings 612 are different, processing accuracy cannot be improved through adjusting the substrate 6's position.

Besides, when the beam is emitted to a position that is away from the center, the beam will be adjusted by the mirror assembly to be deflected to the concentrating lens set with a larger inclined incident angle. So, the beam emitted out of the concentrating lens set is also more inclined, causing poor processing quality and accuracy. To have a better processing quality and accuracy, the via-forming process can only be done in a smaller area on the substrate, consuming more time for processing.

### SUMMARY OF THE INVENTION

The main objective of the present invention is to provide a laser direction guiding assembly and a laser processing device to resolve drawbacks that when a conventional mirror assembly adjusts a route angle of a laser beam, a larger angular difference will occur between two light routes at two opposite sides of the doughnut-shaped beam. Therefore, the laser beam that passes a concentrating lens set will have a larger inclined angle, causing poor processing quality and accuracy, or being highly time-consuming in processing.

The laser direction guiding assembly is mounted in and controlled by a laser processing device, and is configured to adjust a route direction of a laser beam emitted into the laser direction guiding assembly to adjust a coordinate location, in a first direction and in a second direction, of the laser beam on a to-be-processed object when the laser beam is emitted to the to-be-processed object. The first direction and the second direction are perpendicular to each other. The laser direction guiding assembly comprises an offsetting mirror set, a first-axis mirror set, and a second-axis mirror set. The offsetting mirror set comprises an offsetting reflection mirror and an offsetting-mirror-pivoting motor, which is connected to the offsetting reflection mirror and is controlled to drive the offsetting reflection mirror to pivot axially. The first-axis mirror set comprises a first-axis reflection mirror and a first-axis-mirror-pivoting motor, which is connected to the first-axis reflection mirror and is controlled to drive the first-axis reflection mirror to pivot axially. A pivoting axis of the offsetting reflection mirror and a pivoting axis of the first-axis reflection mirror are parallel to each other. The second-axis mirror set comprises a second-axis reflection mirror and a second-axis-mirror-pivoting motor, which is connected to the second-axis reflection mirror and is controlled to drive the second-axis reflection mirror to pivot axially. The pivoting axis of the first-axis reflection mirror and a pivoting axis of the second-axis reflection mirror are non-parallel. The laser beam is emitted to the offsetting reflection mirror to be reflected along an offsetting angle to the first-axis reflection mirror, then the laser beam is reflected by the first-axis reflection mirror to be deflected along a first angle, which is opposite to the offsetting angle to adjust a coordinate along the first direction of the laser beam when the laser beam is emitted to the to-be-processed object. Then, the laser beam is reflected to the second-axis reflection mirror to adjust a coordinate along the second direction of the laser beam when the laser beam is emitted to the to-be-processed object, and to be reflected to a concentrating lens set of the laser processing device to be focused and emitted to the to-be-processed object.

The laser direction guiding assembly is mounted in the laser processing device and is configured to adjust the route direction of the laser beam. The laser processing device controls the laser direction guiding assembly according to coordinates on the first direction and the second direction of to-be-processed positions on the to-be-processed object. The laser processing device controls an inclined angle at which the offsetting-mirror-pivoting motor makes the offsetting reflection mirror pivot, controls an inclined angle at which the first-axis-mirror-pivoting motor makes the first-axis reflection mirror pivot, and controls an inclined angle at which the second-axis-mirror-pivoting motor makes the second-axis reflection mirror pivot. Then, when the laser processing device emits a laser beam to the laser direction guiding assembly, the laser beam will be reflected by the offsetting reflection mirror, the first-axis reflection mirror, and the second-axis reflection mirror in sequence to make the laser beam emitted to one of the to-be-processed positions on the to-be-processed object.

When the laser beam is emitted into the laser direction guiding assembly, the laser beam is reflected by the offsetting reflection mirror along the offsetting angle, and then is reflected by the first-axis reflection mirror along the first angle. The pivoting axis of the offsetting reflection mirror and the pivoting axis of the first-axis reflection mirror are parallel. Because the laser beam is deflected firstly along the offsetting angle and then is deflected along the first angle, and because the offsetting angle and the first angle are opposite and different from each other, an angular difference between two light routes respectively at two opposite sides of the laser beam is modified and reduced. Therefore, when the laser beam is further reflected to the second-axis reflection mirror, the angular difference between the two light routes respectively at the two opposite sides of the laser beam is smaller, and thus the laser beam reflected away from the second-axis reflection mirror also has a smaller angular difference between the two light routes respectively at the two opposite sides of the laser beam. Hence, the laser beam can be emitted into the concentrating lens set with a smaller inclined incident angle, and the beam emitted from the concentrating lens set tends to be vertical, thereby improving processing quality and accuracy, and processing can be done in a larger area to reduce processing time. The laser direction guiding assembly is particularly suitable for a laser processing device emitting a Bessel laser beam.

The laser processing device in accordance with the present invention is configured to process a to-be-processed object through laser. The laser processing device comprises a laser emitter, the laser direction guiding assembly, a concentrating lens set, and a moving platform. The laser emitter emits a laser beam. The laser direction guiding assembly receives the laser beam from the laser emitter. The concentrating lens set is disposed adjacent to the laser direction guiding assembly and receives the laser beam reflected by the laser direction guiding assembly to make the laser beam focus. The moving platform is disposed under the concentrating lens set and is controlled to move along the first direction and the second direction. The to-be-processed object is loaded on the moving platform. The laser emitter emits the laser beam to the laser direction guiding assembly to adjust the route direction of the laser beam. The laser direction guiding assembly reflects the laser beam to the concentrating lens set. The laser beam passes through the concentrating lens set and is emitted and focused on the to-be-processed object on the moving platform.

The laser processing device is configured to process the to-be-processed object through laser, especially the Bessel laser beam. The laser emitter emits the laser beam to the laser direction guiding assembly. The laser direction guiding assembly adjusts the route of the laser beam and reflects the laser beam to the concentrating lens set. The laser beam passes the concentrating lens set and is emitted and focused on the to-be-processed object on the moving platform. The moving platform drives the to-be-processed object to move along the first direction and the second direction, so that different areas on the to-be-processed object can be moved into a field of view (FOV) of the concentrating lens set. By adjusting the route direction of the laser beam through the laser direction guiding assembly, the laser beam enters the concentrating lens set with a smaller inclined incident angle, thereby improving processing quality and accuracy.

### BRIEF DESCRIPTION OF THE DRAWINGS

FIG. 1 is a perspective view of an embodiment of a laser processing device and a laser direction guiding assembly in accordance with the present invention;

FIG. 2 is a perspective view of the laser direction guiding assembly and a concentrating lens set of the laser processing device;

FIG. 3 is a top view of a route of a laser beam emitted by a laser emitter of the laser processing device;

FIG. 4 is a side view of routes of laser beams emitted by the laser emitter of the laser processing device; and

FIG. 5 is a sectional side view of a substrate, having vias processed by a conventional laser processing device.

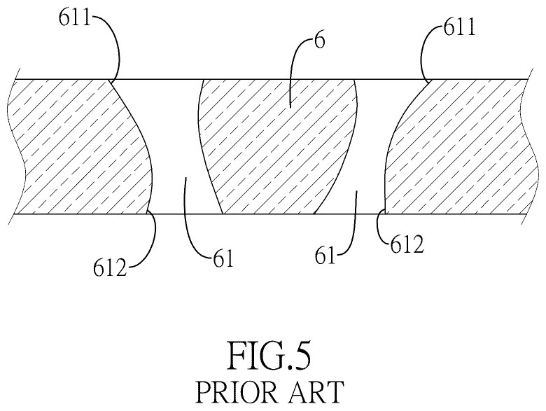

### DETAILED DESCRIPTION OF THE PREFERRED EMBODIMENT

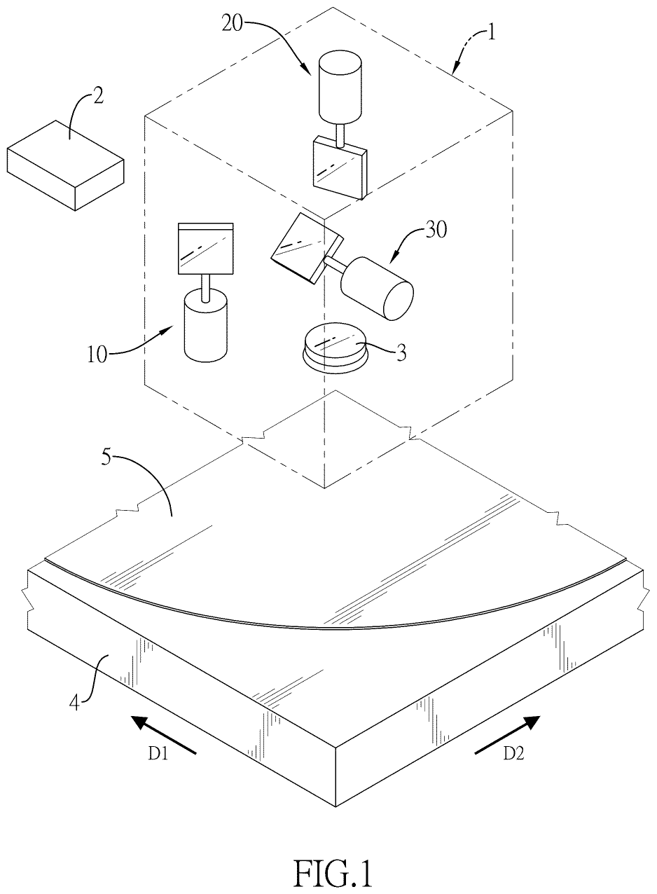

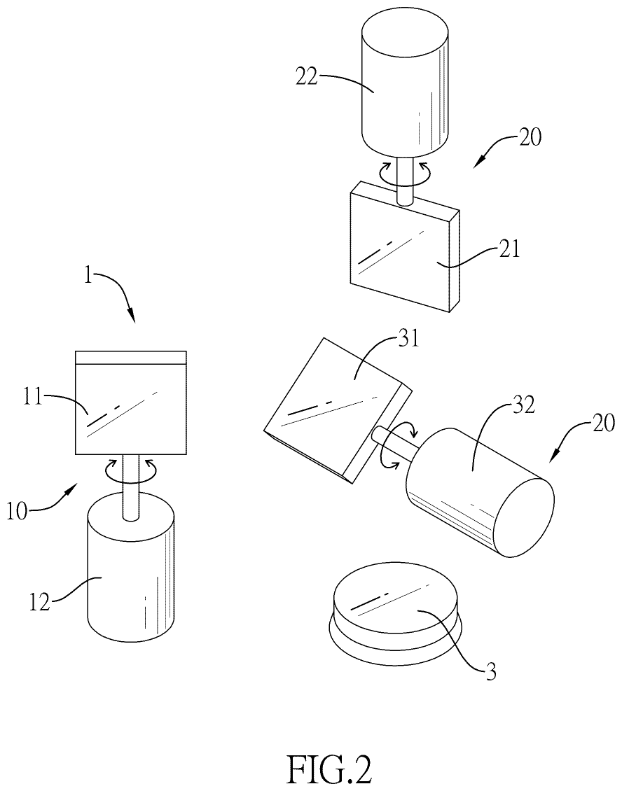

With reference to FIGS. 1 and 2, an embodiment of a laser direction guiding assembly 1 in accordance with the present invention is mounted at and controlled by a laser processing device. The laser direction guiding assembly 1 is configured to adjust a route direction of a laser beam emitted into the laser direction guiding assembly 1 to adjust a coordinate location, in a first direction D1 and a second direction D2, of the laser beam on a to-be-processed object 5 when the laser beam is emitted to the to-be-processed object 5. The first direction D1 and the second direction D2 are perpendicular to each other. The laser direction guiding assembly 11 comprises an offsetting mirror set 10, a first-axis mirror set 20 and a second-axis mirror set 30.

With reference to FIGS. 1 and 2, the offsetting mirror set 10 comprises an offsetting reflection mirror 11 and an offsetting-mirror-pivoting motor 12. The offsetting-mirror-pivoting motor 12 is connected to the offsetting reflection mirror 11 and is controlled to drive the offsetting reflection mirror 11 to pivot axially.

With reference to FIGS. 1 and 2, the first-axis mirror set 20 comprises a first-axis reflection mirror 21 and a first-axis-mirror-pivoting motor 22. The first-axis-mirror-pivoting motor 22 is connected to the first-axis reflection mirror 21 and is controlled to drive the first-axis reflection mirror 21 to pivot axially. A pivoting axis of the offsetting reflection mirror 11 and a pivoting axis of the first-axis reflection mirror 21 are parallel to each other.

With reference to FIGS. 1 and 2, the second-axis mirror set 30 comprises a second-axis reflection mirror 31 and a second-axis-mirror-pivoting motor 32. The second-axis-mirror-pivoting motor 32 is connected to the second-axis reflection mirror 31 and is controlled to drive the second-axis reflection mirror 31 to pivot axially. The pivoting axis of the first-axis reflection mirror 21 and a pivoting axis of the second-axis reflection mirror 31 are non-parallel.

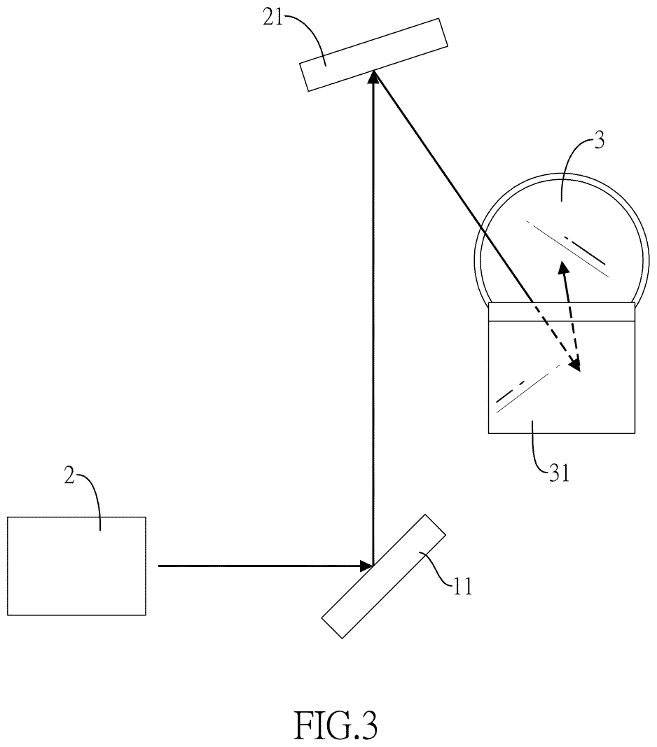

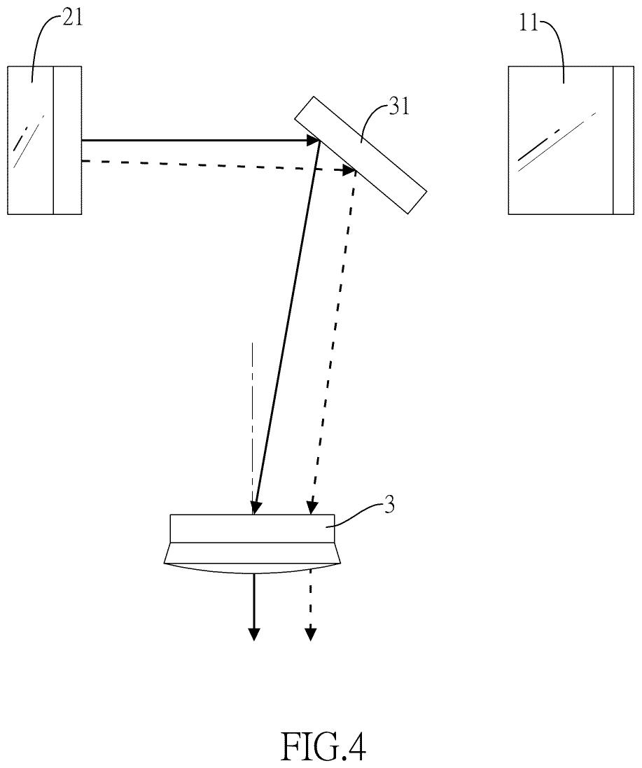

With reference to FIGS. 3 and 4, the laser beam is emitted to the offsetting reflection mirror 11 to be reflected along an offsetting angle to the first-axis reflection mirror 21, and then the laser beam is reflected by the first-axis reflection mirror 21 to be deflected along a first angle, which is opposite to the offsetting angle. The first angle and the offsetting angle are in different directions. The first-axis reflection mirror 21 adjusts a coordinate along the first direction D1 of the laser beam when the laser beam is emitted to the to-be-processed object 5 and reflects the laser beam to the second-axis reflection mirror 31. The second-axis reflection mirror 31 adjusts a coordinate along the second direction D2 of the laser beam when the laser beam is emitted to the to-be-processed object 5 and reflects the laser beam to a concentrating lens set 3 of the laser processing device. The laser beam passes the concentrating lens set 3 to be emitted toward the to-be-processed object 5 and is focused on the to-be-processed object 5.

Preferably, as shown in FIG. 1, the first direction D1 and the second direction D2 are perpendicular to each other and are both horizontal. Besides, as shown in FIG. 2, the offsetting mirror set 10 and the first-axis mirror set 20 are arranged face to face and opposite to each other. The offsetting-mirror-pivoting motor 12 makes the offsetting reflection mirror 11 pivot vertically. The pivoting axis of the first-axis reflection mirror 21 and the pivoting axis of the second-axis reflection mirror 31 are perpendicular to each other. The second-axis-mirror-pivoting motor 32 makes the second-axis reflection mirror 31 pivot horizontally.

With reference to FIG. 1, an embodiment of a laser processing device in accordance with the present invention is configured to process a to-be-processed object 5 through a laser beam. The laser processing device comprises a laser emitter 2, a laser direction guiding assembly 1 as mentioned above, a concentrating lens set 3 and a moving platform 4.

With reference to FIG. 3, the laser emitter 2 emits a laser beam. The laser direction guiding assembly 1 receives the laser beam from the laser emitter 2. With reference to FIGS. 1 and 3, the concentrating lens set 3 is disposed adjacent to the laser direction guiding assembly 1, receives the laser beam reflected by the laser direction guiding assembly 1, and makes the laser beam focus. With reference to FIG. 1, the moving platform 4 is disposed under the concentrating lens set 3 and is controlled to move along the first direction D1 and along the second direction D2. The to-be-processed object 5 is loaded on the moving platform 4. The moving platform 4 drives the to-be-processed object 5 to move along the first direction D1 and the second direction D2, so that different areas on the to-be-processed object 5 can be moved into a field of view (FOV) of the concentrating lens set 3.

Additionally, the laser emitter 2 emits the laser beam to the laser direction guiding assembly 1, which adjusts a route of the laser beam and reflects the laser beam to the concentrating lens set 3. The laser beam passing the concentrating lens set 3 is emitted to and focused on the to-be-processed object 5 on the moving platform 4.

With reference to FIG. 1, the laser direction guiding assembly 1 is mounted at the laser processing device to adjust the route direction of the laser beam according to coordinates in the first direction D1 and the second direction D2 of a to-be-processed position on the to-be-processed object 5. With reference to FIG. 2, the laser processing device controls the offsetting-mirror-pivoting motor 12 of the offsetting mirror set 10 to pivot the offsetting reflection mirror 11, controlling the offsetting reflection mirror 11's inclined angle. The laser processing device controls the first-axis-mirror-pivoting motor 22 of the first-axis mirror set 20 to pivot the first-axis reflection mirror 21, controlling the first-axis reflection mirror 21's inclined angle. The laser processing device controls the second-axis-mirror-pivoting motor 32 of the second-axis mirror set 30 to pivot the second-axis reflection mirror 31, controlling the second-axis reflection mirror 31's inclined angle.

Then, with reference to FIG. 3, when the laser emitter 2 of the laser processing device emits the laser beam to the laser direction guiding assembly 1, the laser beam will be reflected by the offsetting reflection mirror 11, the first-axis reflection mirror 21, and the second-axis reflection mirror 31 in sequence. The laser beam will be emitted to the concentrating lens set 3 and is focused on the to-be-processed position on the to-be-processed object 5 on the moving platform 4, thereby processing laser modification to the to-be-processed position on the to-be-processed object 5.

Additionally, with reference to FIGS. 3 and 4, when the laser beam is emitted into the laser direction guiding assembly 1, the laser beam is first reflected by the offsetting reflection mirror 11 along the offsetting angle, and then is reflected by the first-axis reflection mirror 21 along the first angle. Because the pivoting axis of the offsetting reflection mirror 11 and the pivoting axis of the first-axis reflection mirror 21 are parallel to each other, and the laser beam is firstly deflected along the offsetting angle then deflected along the first angle, an angular difference between two routes at two opposite sides of the laser beam is modified and reduced. So, when the laser beam is later reflected to the second-axis reflection mirror 31, the angular difference between the two routes at the two opposite sides of the laser beam is smaller. Therefore, the laser beam reflected by the second-axis reflection mirror 31 also has a smaller angular difference between the two routes at the two opposite sides of the laser beam. Eventually, the laser beam is emitted into the concentrating lens set 3 with a smaller inclined incident angle, so the beam emitted from the concentrating lens set 3 tends to be vertical, thereby improving processing quality and accuracy, and processing can be done in a larger area to reduce processing time.

Preferably, the laser emitter 2 is a Bessel beam emitter that emits a Bessel beam. Because the laser direction guiding assembly 1 can reduce the angular difference between two routes at two opposite sides of a laser beam, the laser direction guiding assembly 1 is particularly suitable for a laser processing device using the Bessel beam to process.

To sum up, the laser beam is firstly deflected by the offsetting reflection mirror 11, then emitted to the first-axis reflection mirror 21, and then to the second-axis reflection mirror 31. So, when the laser beam is emitted from the second-axis reflection mirror 31, the angular difference between the two routes at the two opposite sides of the laser beam is reduced. Hence, the laser beam is emitted into the concentrating lens set 3 with a smaller inclined angle, the beam emitted from the concentrating lens set 3 tends to be vertical, thereby improving processing quality and accuracy of the laser processing device.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A laser direction guiding assembly mounted in a laser processing device, controlled by the laser processing device, and configured to adjust a route direction of a laser beam emitted into the laser direction guiding assembly to adjust a coordinate location, in a first direction and in a second direction, of the laser beam on a to-be-processed object when the laser beam is emitted to the to-be-processed object; the first direction and the second direction being perpendicular to each other; the laser direction guiding assembly comprising:
an offsetting mirror set comprising
an offsetting reflection mirror; and
an offsetting-mirror-pivoting motor connected to the offsetting reflection mirror and controlled to drive the offsetting reflection mirror to pivot axially;
a first-axis mirror set comprising
a first-axis reflection mirror; and
a first-axis-mirror-pivoting motor connected to the first-axis reflection mirror and controlled to drive the offsetting reflection mirror to pivot axially; a pivoting axis of the offsetting reflection mirror and a pivoting axis of the first-axis reflection mirror being parallel to each other;
a second-axis mirror set comprising
a second-axis reflection mirror; and
a second-axis-mirror-pivoting motor connected to the second-axis reflection mirror and controlled to drive the second-axis reflection mirror to pivot axially; the pivoting axis of the first-axis reflection mirror and a pivoting axis of the second-axis reflection mirror being non-parallel;
wherein the laser beam is emitted to the offsetting reflection mirror to be reflected along an offsetting angle to the first-axis reflection mirror, then the laser beam is reflected by the first-axis reflection mirror to be deflected along a first angle, which is different from the offsetting angle to adjust a coordinate along the first direction of the laser beam when the laser beam is emitted to the to-be-processed object; the laser beam is reflected to the second-axis reflection mirror to adjust a coordinate along the second direction of the laser beam when the laser beam is emitted to the to-be-processed object, and to be reflected to a concentrating lens set of the laser processing device to be focused and emitted to the to-be-processed object.

2. The laser direction guiding assembly as claimed in claim 1, wherein the offsetting mirror set and the first-axis mirror set are arranged face to face and opposite to each other; the offsetting-mirror-pivoting motor makes the offsetting reflection mirror pivot vertically.

3. The laser direction guiding assembly as claimed in claim 1, wherein the pivoting axis of the first-axis reflection mirror and the pivoting axis of the second-axis reflection mirror are perpendicular to each other.

4. The laser direction guiding assembly as claimed in claim 2, wherein the second-axis-mirror-pivoting motor makes the second-axis reflection mirror pivot horizontally.

5. The laser direction guiding assembly as claimed in claim 1, wherein the first angle is opposite to the offsetting angle.

6. The laser direction guiding assembly as claimed in claim 4, wherein the first angle is opposite to the offsetting angle.

7. A laser processing device configured to process a to-be-processed object through laser; the laser processing device comprising:
a laser emitter emitting a laser beam;
a laser direction guiding assembly receiving the laser beam from the laser emitter; the laser direction guiding assembly controlled by the laser processing device and configured to adjust a route direction of the laser beam emitted into the laser direction guiding assembly to adjust a coordinate location, in a first direction and in a second direction, of the laser beam on the to-be-processed object when the laser beam is emitted to the to-be-processed object, the first direction and the second direction being perpendicular to each other; the laser direction guiding assembly comprising
an offsetting mirror set comprising
an offsetting reflection mirror; and
an offsetting-mirror-pivoting motor connected to the offsetting reflection mirror and controlled to drive the offsetting reflection mirror to pivot axially;
a first-axis mirror set comprising
a first-axis reflection mirror; and
a first-axis-mirror-pivoting motor connected to the first-axis reflection mirror and controlled to drive the offsetting reflection mirror to pivot axially; a pivoting axis of the offsetting reflection mirror and a pivoting axis of the first-axis reflection mirror being parallel to each other;
a second-axis mirror set comprising
a second-axis reflection mirror; and
a second-axis-mirror-pivoting motor connected to the second-axis reflection mirror and controlled to drive the second-axis reflection mirror to pivot axially; the pivoting axis of the first-axis reflection mirror and a pivoting axis of the second-axis reflection mirror being non-parallel;
a concentrating lens set disposed adjacent to the laser direction guiding assembly and receiving the laser beam reflected by the laser direction guiding assembly to make the laser beam focus; and
a moving platform disposed under the concentrating lens set and controlled to move along the first direction and the second direction;
wherein the to-be-processed object is loaded on the moving platform; the laser emitter emits the laser beam to the laser direction guiding assembly; the laser beam is emitted to the offsetting reflection mirror to be reflected along an offsetting angle to the first-axis reflection mirror, then the laser beam is reflected by the first-axis reflection mirror to be deflected along a first angle, which is different from the offsetting angle, to adjust a coordinate along the first direction of the laser beam when the laser beam is emitted to the to-be-processed object; the laser beam is reflected to the second-axis reflection mirror to adjust a coordinate along the second direction of the laser beam when the laser beam is emitted to the to-be-processed object, and to be reflected to the concentrating lens set; the laser beam passes the concentrating lens set and is focused on the to-be-processed object on the moving platform.

8. The laser direction guiding assembly as claimed in claim 7, wherein the laser emitter is a Bessel beam emitter and is configured to emit a Bessel beam.

9. The laser direction guiding assembly as claimed in claim 7, wherein the offsetting mirror set and the first-axis mirror set are arranged face to face and opposite to each other; the offsetting-mirror-pivoting motor makes the offsetting reflection mirror pivot vertically.

10. The laser direction guiding assembly as claimed in claim 7, wherein the pivoting axis of the first-axis reflection mirror and the pivoting axis of the second-axis reflection mirror are perpendicular to each other.

11. The laser direction guiding assembly as claimed in claim 9, wherein the second-axis-mirror-pivoting motor makes the second-axis reflection mirror pivot horizontally.

12. The laser direction guiding assembly as claimed in claim 7, wherein the first angle is opposite to the offsetting angle.

13. The laser direction guiding assembly as claimed in claim 11, wherein the first angle is opposite to the offsetting angle.
